(19) United States
(12) Patent Application Publication
(10) Pub. No.: US 2003/0214758 A1
(43) Pub. Date: Nov. 20, 2003

(54) Flex clamp in a disc drive for retaining a voice coil motor magnetic pole on a base

(75) Inventors: Kelly Mei Kee Lim, Singapore (SG); CheeWai SeeToh, Singapore (SG); Johaan See Jee Koong, Singapore (SG); WaiOnn Chee, Singapore (SG); Niroot Jierapipatanakul, Singapore (SG)

Correspondence Address: Merchant & Gould P.C., P.O. Box 2903, Minneapolis, MN, 55402-0903, US

(73) Assignee: Seagate Technology LLC

(21) Appl. No.: 10/321,169

(22) Filed: Dec. 16, 2002

Related U.S. Application Data
(60) Provisional application No. 60/382,147, filed on May 20, 2002.

(51) Int. Cl. G11B 5/55

(52) U.S. Cl. 360/264.7

(57) ABSTRACT

A disc drive includes an actuator assembly mounted on a base. The actuator assembly is able to move a transducer head over a data surface of a disc. The disc drive also includes a voice coil motor that is able to rotate the actuator assembly. The voice coil motor includes a bottom pole adjacent the base, an opposing top pole adjacent the cover and a coil mounted on the actuator assembly between the top and bottom poles. A flexible cable is coupled to the head and has first and second ends and a middle section extending between the first and second ends, wherein the first end is secured to the actuator assembly. The disc drive also includes a flex clamp fastened to the base and securing the second end of the flexible cable to the base. The flex clamp has a body and a clamp arm extending from the body. The clamp arm extends over the bottom pole of the voice coil motor and retains the bottom pole between the clamp arm and the base.

### RELATED APPLICATIONS

This application claims priority of U.S. provisional application Serial No. 60/382,147, filed May 20, 2002.

### FIELD OF THE INVENTION

This application relates generally to disc drives and more particularly to a flex clamp in a disc drive for clamping a voice coil motor magnetic pole to a base of the disc drive.

### BACKGROUND OF THE INVENTION

A typical disc drive includes a base to which various components of the disc drive are mounted. A top cover cooperates with the base to form an internal, closed environment for the disc drive components. The components in this closed environment include a spindle motor, which rotates one or more discs, and a rotary actuator assembly, which writes information to and reads information from tracks on the discs. The actuator assembly includes a plurality of actuator arms, which extend towards the discs, with one or more flexures extending from each of the actuator arms. Mounted at the distal end of each of the flexures is a head, which flies above the corresponding surface of the associated disc.

During a seek operation, the track position of the heads is controlled through the use of a voice coil motor. The voice coil motor includes a coil attached to the actuator assembly, as well as one or more permanent magnet pairs connected to top and bottom pole plates that cooperate to establish a magnetic field in the gap between the pole plates in which the coil is immersed.

A flex assembly provides the requisite electrical connection paths for the actuator assembly while allowing pivotal movement of the actuator assembly during operation. The flex assembly includes a flexible ribbon cable that extends from the actuator assembly to a flex clamp that physically orients the flexible cable with respect to the actuator arms and facilitates fastening the flexible cable to a fixed location in the base.

Accordingly there is a need for a convenient way to secure both ends of the bottom pole magnet to the base even when the top cover is removed. Screws are often used to secure these components to the base of the disc drive. Each screw contributes to the cost and the time required to assemble a disc drive. The present invention provides a solution to this and other problems, and offers other advantages over the prior art.

### SUMMARY OF THE INVENTION

Against this backdrop the present invention has been developed. An embodiment of the present invention is a disc drive including an actuator assembly mounted on a base. The actuator assembly is able to move a transducer head over a data surface of a disc. The disc drive also includes a voice coil motor that is able to rotate the actuator assembly. The voice coil motor includes a bottom pole adjacent the base, an opposing top pole adjacent the cover forming a gap between the poles, and a coil mounted on the actuator assembly in the gap between the top and bottom poles. A flexible cable is coupled to the head and has first and second ends and a middle section extending between the first and second ends, wherein the first end is secured to the actuator assembly. The disc drive also includes a flex clamp fastened to the base and securing the second end of the flexible cable to the base. The flex clamp has a body and a clamp arm extending from the body. The clamp arm extends over the bottom pole of the voice coil motor and retains the bottom pole between the clamp arm and the base.

An embodiment of the present invention may be alternatively described as a disc drive flex clamp fastened to a base of a disc drive and securing an end of a flexible cable to the base. The flex clamp includes a body, a clamp arm, and a support arm. The clamp arm extends from the body and over a portion of a bottom pole of a disc drive voice coil motor. The clamp arm retains the portion of the bottom pole between the clamp arm and the base. The support arm extends from the body and supports a middle section of the flexible cable as the middle section extends from the flex clamp.

These and various other features as well as advantages which characterize the present invention will be apparent from a reading of the following detailed description and a review of the associated drawings.

### BRIEF DESCRIPTION OF THE DRAWINGS

FIG. 1 is a partially exploded perspective view of a disc drive incorporating a preferred embodiment of the present invention showing the primary internal components.

FIG. 2 is a broken away top plan view of a portion of a disc drive according to a preferred embodiment of the present invention.

FIG. 3 is a separate top perspective view of a flex clamp according to a preferred embodiment of the present invention.

FIG. 4 is a separate bottom perspective view of the flex clamp of FIG. 3.

FIG. 5 is a sectional view taken along line 5-5 of FIG. 2.

### DETAILED DESCRIPTION

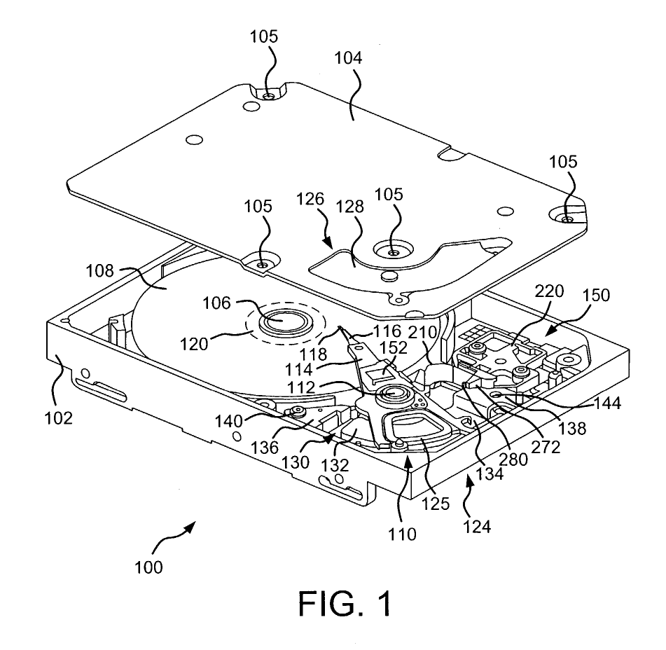

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The top cover 104 includes fastener holes 105 that receive fasteners for securing the top cover 104 to the base 102. The internal disc drive components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider enabling the head 118 to fly in close proximity above the corresponding surface of the associated disc 108.

During a seek operation, the track position of the heads 118 is controlled through the use of a voice coil motor 124, which includes a coil 125 attached to the actuator assembly 110. The voice coil motor 124 also includes a top pole 126 that is integrated into the top of the top cover 104. The top pole 126 includes a permanent top pole magnet 128. The voice coil motor 124 also includes a bottom pole 130 that includes a permanent bottom pole magnet 132 attached to a metallic bottom pole plate 134. The bottom pole plate 134 includes a front end 136 and an opposing rear end 138. A front-end fastener 140 secures the front end 136 to the base 102. The rear end 138 rises to form a shoulder that defines a fastener hole 144. A fastener extends through the cover 104 and through the fastener hole 144 to fix the rear end 138 of the bottom pole plate 134 relative to the base 102 and the cover 104 when the cover 104 is fastened to the base 102. The rear end 138 abuts the top cover 104 to complete the magnetic circuit between the top pole 126 and the bottom pole 130.

The top pole 126 and the bottom pole 130 establish a magnetic field between them in which the coil 125 is immersed. The controlled application of current to the coil 125 causes magnetic interaction between the permanent magnets 128 and 132 and the coil 125 so that the coil 125 moves in accordance with the well-known Lorentz relationship. As the coil 125 moves, the arms 114 in the actuator assembly 110 pivot about the bearing shaft assembly 112, and the heads 118 are caused to move substantially across the surfaces of the discs 108.

The spindle motor 106 is typically de-energized when the disc drive 100 is not in use for extended periods of time. The heads 118 are typically moved over park zones 120 near the inner diameter of the discs 108 when the spindle motor 106 is de-energized. The heads 118 are secured over the park zones 120 through the use of an actuator latch arrangement, which prevents inadvertent rotation of the actuator assembly 110 when the heads are parked.

A flex assembly 150 provides the requisite electrical connection paths for the actuator assembly 110 while allowing pivotal movement of the actuator assembly 110 during operation. The flex assembly 150 may include a printed circuit board 152 to which head wires (not shown) are connected; the head wires being routed along the actuator arms 114 and the flexures 116 to the heads 118. The printed circuit board 152 typically includes circuitry for controlling the write currents applied to the heads 118 during a write operation and a preamplifier for amplifying read signals generated by the heads 118 during a read operation.

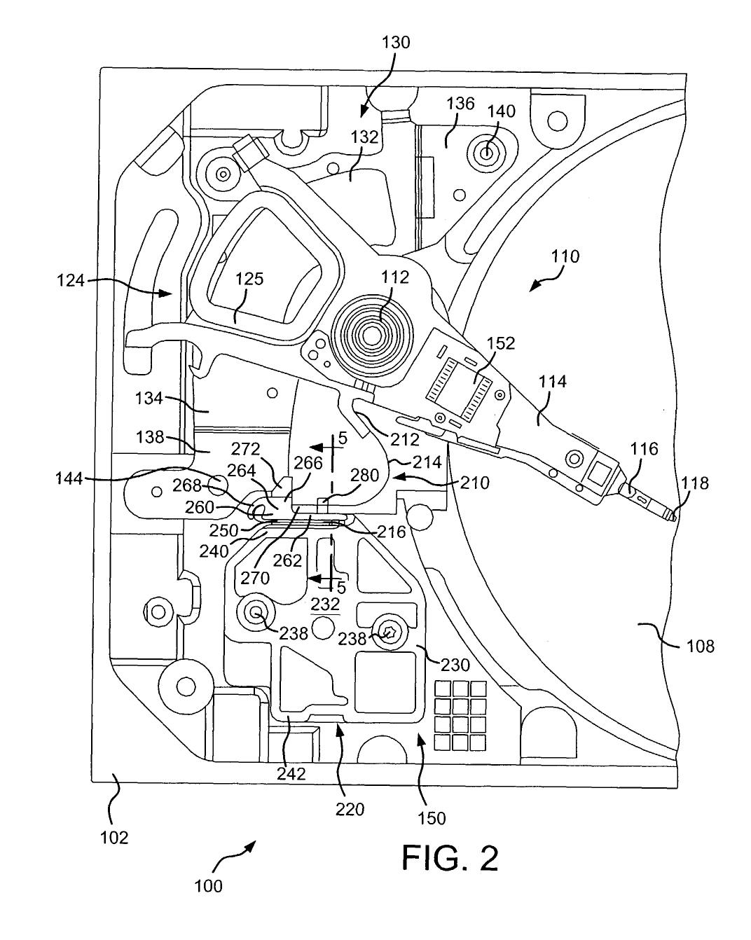

The flex assembly 150 also includes a flat flexible cable 210. Referring to FIG. 2, the flexible cable 210 is coupled to the printed circuit board 152 and is secured to the actuator assembly 110 at an actuator end 212. A middle section 214 of the flexible cable 210 follows an arcuate path about a vertical axis from the actuator assembly 110 to a flex clamp end 216 of the flexible cable 210 that is secured to the flex clamp 220, as described in more detail below.

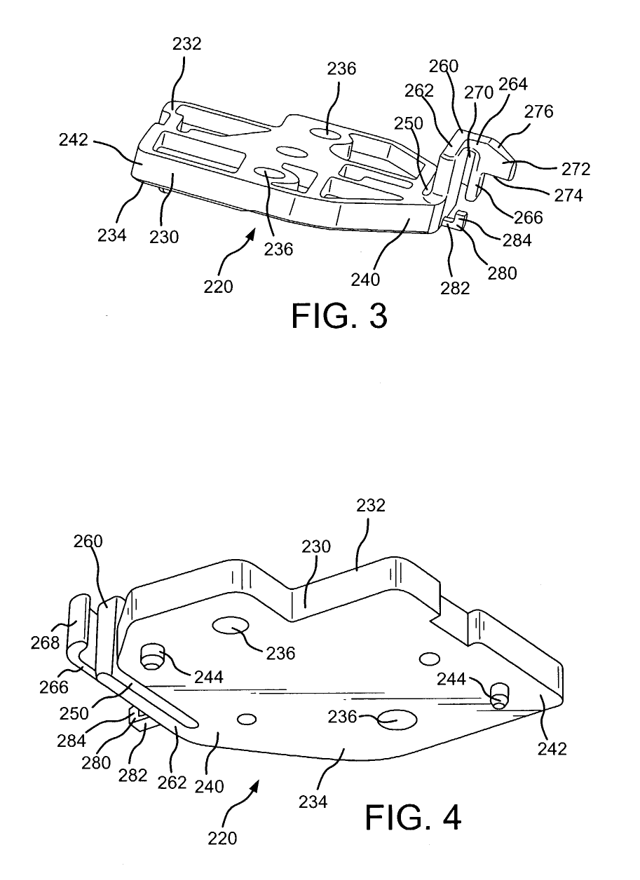

The flex clamp 220, which is shown separately in FIGS. 3-4, includes a generally rectangular polymer body 230 having a top surface 232 and an opposing bottom surface 234. The body 230 defines vertically extending securing holes 236 that receive fasteners 238 to secure the body 230 to the base 102. A front end 240 of the body 230 faces toward the actuator assembly 110, and an opposing rear end 242 of the body faces away from the actuator assembly 110. Locating pins 244 depend from the bottom surface 234 to aid in locating the flex clamp 220 relative to the base 102.

A pass-through slot 250 extends vertically through the front end 240 of the body 230. A guide feature 260 includes a rear wall 262 that extends up from the front side of the slot 250, a bridge 264 that extends away from the body 230, and a front wall 266 that depends from the bridge 264. The front wall 266 also extends sideways beyond the bridge 264 where it has a bend 268 that curves rearward in a horizontal plane so that the bend 268 wraps partially around a distal end of the rear wall 262. The guide feature 260 defines a channel between the rear wall 262 and the front wall 266 below the bridge 264.

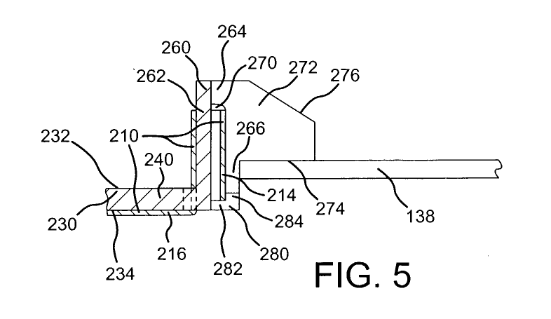

A clamp arm 272 that is preferably integrally formed with the body 230 extends forward from the front wall 266 of the guide feature 260. The clamp arm 272 preferably includes a substantially horizontal bottom surface 274 and a top surface 276 that slopes forward and down toward the bottom surface 274 so that the height of the clamp arm 272 decreases as the clamp arm extends away from the guide feature 260. The bottom surface 274 presses down on the rear end 138 of the bottom pole plate 134 as shown in FIG. 5. The rear end 138 is thereby clamped between the clamp arm 272 and the base 102 so that the clamp arm 272 overcomes the magnetic force of the top pole 126 and prevents the rear end 138 from lifting away from the base 102 even if the cover 104 and the top pole 126 are raised. The clamp arm 272 is preferably sufficiently rigid and bulky to maintain clamping pressure on the rear end 138 of the bottom pole plate 134 during the normal life of the disc drive 100. Notably, the clamp arm could retain the rear end 138 between the clamp arm 272 and the base 102 even without constantly engaging the rear end 138, such as if there were a gap between the rear end 138 and the clamp arm 172.

The flex clamp 220 also includes an L-shaped support arm 280 that is integrally formed with the body 230. The support arm 280 has a horizontal aspect 282 that extends forward from the body 230 and a vertical aspect 284 that extends up from the forward terminus of the horizontal aspect 282.

The flex clamp 220, including the body 230, the clamp arm 272, and the support arm 280, is preferably a unitary molded polymer member. The flex clamp 220 can be manufactured using standard materials and manufacturing methods for flex clamps.

As shown in FIGS. 2 and 5, the middle section 214 of the flexible cable 210 rests on the horizontal aspect 282 of the support arm 280, and the vertical aspect 284 guides the middle section 214 of the flexible cable 210 to prevent the flexible cable 210 from sliding off the horizontal aspect 282. The support arm 280 inhibits the middle section 214 from sagging vertically between the guide feature 260 and the actuator assembly 110.

The flexible cable 210 continues past the support arm 280 to the channel 270, where it extends along the front wall 266 of the guide feature 260, around the bend 268, and back along the rear wall 262 to form a reverse bend. The flexible cable 210 then passes down through the slot 250. The bridge 264 prevents the flexible cable 210 from lifting up from the support arm 280. The flex clamp end 216 of the flexible cable 210 extends from the slot 250 beneath the bottom surface 234 and is clamped between the flex clamp 220 and the base 102. The signal lines of the flexible cable 210 are communicated through the base 102 to a disc drive printed circuit board (not shown) mounted to the bottom side of the disc drive 100.

Thus, the clamp arm 272 clamps the bottom pole plate 134 in place and the support arm 280 inhibits sagging of the middle section 214 of the flexible cable 210. These advantages are achieved without adding significant manufacturing costs to the disc drive 100 because the clamp arm 272 and the support arm 280 are preferably integrated to form a unitary member with the body 230 of the flex clamp 220, and thus no additional parts are required. In particular, the clamp arm 272 holds the bottom pole plate 134 in place even when the top cover 104 is removed, such as for reworking the disc drive 100. The clamp arm 272 does this without requiring a separate fastener. The clamp arm 272 thereby decreases the assembly time and overall cost of the disc drive 100 by reducing the number of fasteners, such as screws, needed for the disc drive 100.

An embodiment of the present invention may be described as a disc drive (such as 100) including an actuator assembly (such as 110) mounted on a base (such as 102) operable to move a transducer head (such as 118) over a data surface of a disc (such as 108). The disc drive also includes a voice coil motor (such as 124) that is able to rotate the actuator assembly. The voice coil motor includes a bottom pole (such as 130) adjacent the base, an opposing top pole (such as 126) adjacent the cover forming a gap between the poles, and a coil (such as 125) mounted on the actuator assembly in the gap between the top and bottom poles. A flexible cable (such as 210) is coupled to the head and has first and second ends (such as 212 and 216) and a middle section (such as 214) extending between the first and second ends, wherein the first end is secured to the actuator assembly. The disc drive also includes a flex clamp (such as 220) fastened to the base and securing the second end of the flexible cable to the base. The flex clamp has a body (such as 230) and a clamp arm (such as 272) extending from the body, the clamp arm extending over the bottom pole of the voice coil motor and retaining the bottom pole between the clamp arm and the base.

The flex clamp preferably has a unitary member including the body and the clamp arm. The bottom pole may have one end (such as 136) that is secured to the base by a fastener (such as 140) and another end (such as 138) that is retained on the base by the clamp arm. A top cover (such as 104) preferably clamps the bottom pole to the base when the top cover is fastened to the base.

The flex clamp preferably includes a pair of walls (such as 262 and 266) joined by a bridge (such as 264) to form a channel (such as 270) between the walls, the channel receiving a portion of the flexible cable. The clamp arm may extend from one of the walls. The flex clamp may also include a support arm (such as 280) extending from the body of the flex clamp. The support arm supports the middle section of the flexible cable as the middle section extends from the flex clamp toward the actuator assembly. The support arm and the body of the flex clamp preferably form a channel and a bottom edge of the flexible cable is seated in the channel, such that the support arm inhibits sagging of the middle section of the flexible cable. In a preferred embodiment, the flex clamp includes a polymer material.

An embodiment of the present invention may be alternatively described as a flex clamp (such as 220) fastened to a base (such as 102) of a disc drive (such as 100) and securing an end of a flexible cable (such as 210) to the base. The flex clamp includes a body (such as 230), a clamp arm (such as 272), and a support arm (such as 280). The clamp arm extends from the body and over a portion of a bottom pole (such as 130) of a disc drive voice coil motor (such as 124). The clamp arm retains the portion of the bottom pole between the clamp arm and the base. The support arm extends from the body and supports a middle section (such as 214) of the flexible cable as the middle section extends from the flex clamp.

Stated yet another way, an embodiment of the present invention may be alternatively described as a disc drive (such as 100). The disc drive includes a flexible cable (such as 210) coupled to a head (such as 118) having first and second ends (such as 212 and 216) and a middle section (such as 214) extending between the first and second ends. The first end is secured to an actuator assembly (such as 110) in the disc drive. The disc drive also includes means for securing the second end of the flexible cable to a disc drive base (such as 102) and for retaining a bottom pole (such as 130) of a voice coil motor (such as 130) between a clamp arm (such as 272) and the base.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the flex clamp 220 can include either the clamp arm 272 or the support arm 280 without including the other. Numerous other changes may be made which will readily suggest themselves to those skilled in the art and which are encompassed in the spirit of the invention disclosed and as defined in the appended claims.

What is claimed is:

1. A disc drive having a base, a cover, and a spindle motor mounted on the base that is operable to spin a disc, the disc drive comprising:
an actuator assembly mounted on the base operable to move a transducer head over a data surface of the disc;
a voice coil motor operable to rotate the actuator assembly, the voice coil motor including a bottom pole adjacent the base, an opposing top pole adjacent the cover forming a gap between the poles, and a coil mounted on the actuator assembly in the gap between the top and bottom poles;
a flexible cable coupled to the head having first and second ends and a middle section extending between the first and second ends, wherein the first end is secured to the actuator assembly; and
a flex clamp fastened to the base and securing the second end of the flexible cable to the base, wherein the flex clamp comprises a body and a clamp arm extending from the body, the clamp arm extending over the bottom pole of the voice coil motor and retaining the bottom pole between the clamp arm and the base.

2. The disc drive of claim 1, wherein the flex, clamp comprises a unitary member including the body and the clamp arm.

3. The disc drive of claim 1, wherein the bottom pole has one end that is secured to the base by a fastener and another end that is retained on the base by the clamp arm.

4. The disc drive of claim 1, wherein the top cover clamps the bottom plate to the base when the top cover is fastened to the base.

5. The disc drive of claim 1, wherein the flex clamp includes a pair of walls joined by a bridge to form a channel between the walls, the channel receiving a portion of the flexible cable.

6. The disc drive of claim 5, wherein clamp arm extends from one of the walls.

7. The disc drive of claim 6, wherein flex clamp further comprises a support arm extending from the body of the flex clamp, the support arm supporting the middle section of the flexible cable as the middle section extends from the flex clamp toward the actuator assembly.

8. The disc drive of claim 7, wherein the support arm and the body of the flex clamp form a channel and a bottom edge of the flexible cable is seated in the channel.

9. The disc drive of claim 7, wherein the support arm inhibits sagging of the middle section of the flexible cable.

10. The disc drive of claim 1, wherein the flex clamp comprises a polymer material.

11. In a disc drive having a base, a cover, a spindle motor mounted on the base that is operable to spin a disc, an actuator assembly mounted on the base that is operable to move a transducer head over a data surface of the disc, a voice coil motor operable to rotate the actuator assembly, the voice coil motor having top and bottom magnetic poles and a coil mounted on the actuator assembly between the top and bottom poles, and a flexible cable coupled to the head having first and second ends and a middle section extending between the first and second ends, wherein the first end is secured to the actuator assembly, a flex clamp fastened to the base and securing the second end of the flexible cable to the base, the flex clamp comprising:
a body;
a clamp arm extending from the body and over a portion of the bottom pole, the clamp arm retaining the portion of the bottom pole between the clamp arm and the base; and
a support arm extending from a body of the flex clamp, the support arm supporting the middle section of the flexible cable as the middle section extends from the flex clamp.

12. The flex clamp of claim 11, wherein the body, the clamp arm, and the support arm form a unitary member.

13. The flex clamp of claim 11, wherein the bottom pole has one end that is secured to the base by a fastener and another end that is clamped to the base by the clamp arm.

14. The flex clamp of claim 11, wherein the top cover clamps the bottom plate to the base when the top cover is fastened to the base.

15. The flex clamp of claim 14, wherein the flex clamp further comprises a pair of walls joined by a bridge to form a channel between the walls, the channel receiving a portion of the flexible cable.

16. The flex clamp of claim 15, wherein clamp arm extends from one of the walls.

17. The flex clamp of claim 11, wherein the support arm and the body of the flex clamp form a channel and a bottom edge of the flexible cable is seated in the channel so that the support arm inhibits sagging of the middle section of the flexible cable.

18. The flex clamp of claim 11, wherein the flex clamp comprises a polymer material.

19. A disc drive having a base, a cover, a spindle motor mounted on the base that is operable to spin a disc, an actuator assembly mounted on the base that is operable to move a head over a data surface of the disc, a voice coil motor operable to rotate the actuator assembly, the voice coil motor having bottom and top magnetic poles forming a gap between the poles, and a coil mounted on the actuator assembly in the gap between the top and bottom poles, the disc drive comprising:
a flexible cable coupled to the head having first and second ends and a middle section extending between the first and second ends, wherein the first end is secured to the actuator assembly; and
means for securing the second end of the flexible cable to the base and for retaining the bottom pole between a clamp arm and the base.

20. The disc drive of claim 19, wherein the means for securing and clamping comprises a flex clamp secured to the base.

21. The disc drive of claim 20, wherein the flex clamp comprises a body, and the clamp arm and the body are both part of a unitary member.

22. The disc drive of claim 19, wherein the means for securing and clamping further comprises means for supporting the middle section of the flexible cable.

23. The disc drive of claim 22, wherein the means for securing, clamping, and supporting comprises a flex clamp secured to the base, the flex clamp comprising a support arm extending from a body of the flex clamp, the support arm supporting the middle section of the flexible cable as the middle section extends from the flex clamp toward the actuator assembly.
